(19) United States
(12) Patent Application Publication
(10) Pub. No.: US 2026/0238263 A1
(43) Pub. Date: Aug. 13, 2026

(54) ENERGY-EFFICIENT MASSIVE MIMO BEAMFORMING WITH MACHINE LEARNING OPTIMIZATION

(71) Applicant: Telefonaktiebolaget LM Ericsson (publ), Stockholm (SE)

(72) Inventors: Hamed HOJATIAN, Montreal (CA); François LEDUC-PRIMEUA, Montreal (CA); Jérémy NADAL, Brest Brittany (FR); Zobeir MLIKA, Longueuil (CA); Jean-François FRIGON, Brossard (CA)

(73) Assignee: Telefonaktiebolaget LM Ericsson (publ), Stockholm (SE)

(21) Appl. No.: 19/469,345

(22) PCT Filed: Mar. 30, 2023
(86) PCT No.: PCT/IB2023/053214

§ 371 Date: Sep. 25, 2025

(51) Int. Cl. H04B 7/0426; G06N 3/088; H04B 7/0417; H04B 7/0452; H04B 7/06

(52) U.S. Cl. CPC H04B 7/0426; H04B 7/0417; H04B 7/0452; H04B 7/0626; H04B 7/0691; G06N 3/088

(57) ABSTRACT

Novel methods and systems are proposed, driven by unsupervised DNN, to design the optimal energy-efficient hardware configurations and antenna selections for hybrid beamforming and fully digital precoding by developing an accurate energy model for each beamforming structure of a massive MIMO system. The energy model can include the power consumption and insertion loss of all components, such as combiners, mixers, power amplifiers, and more. The design of an intelligent loss function can provide various trade-offs between energy consumption and spectral efficiency. It considers the spectral efficiency, the energy efficiency, and the number of active users in the system. The training of the deep unsupervised learning approach can use imperfect channel state information. Consequently, the entire process of proposed DL-based solutions is based on imperfect CSI.

### TECHNICAL FIELD

The present disclosure generally relates to the technical field of wireless communications and more particularly to beamforming techniques.

### BACKGROUND

Modem wireless communication has been revolutionized by massive multiple-input multiple-output (mMIMO) technologies, where a base station (BS) equipped with a large number of antennas transmits to multiple users. Hybrid beamforming (HBF) has been proposed to improve the energy efficiency and reduce the cost of massive MIMO systems through a reduction of the number of radio frequency (RF) chains in the transmitter [2]. HBF uses a combination of an analog precoder consisting of phase-shifters and combiners, and a digital precoder. In general, three types of hybrid beamforming structures are proposed: fully connected HBF (FC-HBF), fixed subarray HBF (FSA-HBF), and dynamic subarray HBF (DSA-HBF). In FC-HBF, each RF chain is connected to all the antennas through a phase-shifter, combiners, and power amplifier. In FSA-HBF, each RF chain is connected to a subset of antennas and the combiners are removed from the structure to improve the implementation cost. To increase the flexibility of the FSA-HBF, DSA-HBF has been proposed where each antenna is connected to a multiplexer. These multiplexers can dynamically change the connection between the antenna and RF chains [7].

Thanks to the enormous success of machine learning (ML), particularly deep learning (DL), in a wide variety of engineering fields, deep neural networks (DNNs) have received significant attention in recent years and have been applied to wireless communication systems. Even though training DNNs to solve wireless communication problems can be time-consuming, the DNN training can take place offline and only the trained DNN model can be used to make online decisions, which reduces the online computational complexity. There have been several studies that discussed the use of DNNs to address difficult problems within the physical layer, employing supervised learning, unsupervised learning, and reinforcement learning (RL). On the one hand, in supervised learning, the time spent in preparing the optimal values (or the labels) is not negligible and may seem infeasible in practice [1]. Also, the labels must be prepared each time the machine learning model is retrained with new datasets. On the other hand, reinforcement learning is a promising machine learning approach where the agent interacts with its environment and makes decisions accordingly [5]. In general, no dataset is required for reinforcement learning. That is, active online data collection is performed as the agent is interacting with its environment in a trial-and-error fashion. Online data collection can be expensive due to a large amount of collected data. Furthermore, since the action space for HBF is large and continuous, thus, the convergence of the reinforcement learning model will require many experiments (i.e., data collection), which makes it complex for HBF in mMIMO systems.

There currently exist certain challenges in the technology identified above. The current solutions in the context of DL-based beamforming consider a specific HBF structure, and they are limited to a predefined HBF structure. Furthermore, they rely on a supervised loss function, imposing that the optimal values should be available as a target, which is computationally expensive and time consuming. There are also some works in unsupervised learning that propose to maximize the spectral efficiency of predefined beamforming structure without considering hardware constraints or energy efficiency. Moreover, one of the most prominent techniques for designing HBF consists in minimizing the Euclidean distance between the desired fully digital precoder (FDP) and its hybrid counterpart, which is the objective function used for HBF design [1-6]. Unfortunately, this technique is required to design the FDP and their performance depends on good channel state information (CSI) acquisition. As a result, designing HBF for the structures that achieves near-optimal performance not only has a high computational cost but also requires a perfect knowledge of CSI while this assumption is hard to achieve in real situations.

### SUMMARY

One embodiment under the present disclosure comprises a method performed by a base station for performing hybrid beamforming or fully digital precoding e.g., in a MIMO system. The method includes measuring a power consumption and an insertion loss of one or more components comprising the base station; determining an energy consumption based on the power consumption and insertion loss; and detecting a number of UEs in communication with the base station. Further steps include measuring spectral efficiency of the base station; comparing the energy consumption, number of UEs, and spectral efficiency to one or more outputs of a trained machine learning model, wherein the trained machine learning model was trained with an intelligent loss function based at least in part on one or more data related to energy consumption, spectral efficiency and number of UEs; and creating one or more beamforming structures with the plurality of antennas based on the trained intelligent loss function.

Another embodiment under the present disclosure is a method performed by a base station comprising a plurality of antennas for performing beamforming or fully digital precoding, e.g., in a MIMO system. The method includes measuring a power consumption and an insertion loss of one or more components comprising the base station; determining an energy consumption based on the power consumption and insertion loss; and detecting a number of UEs in communication with the base station. Further steps in the method include measuring spectral efficiency of the base station; training a machine learning model with an intelligent loss function based at least in part on one or more data related to the energy consumption, spectral efficiency and number of UEs; and creating one or more beamforming structures with the plurality of antennas based on the trained machine learning model.

Another embodiment comprises a network node for performing hybrid beamforming or fully digital precoding. The network node comprises processing circuitry configured to perform any of the steps of any network node or base station-based method described herein; and power supply circuitry configured to supply power to the processing circuitry.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates a base station system embodiment under the present disclosure;

FIGS. 2a-2b illustrate base station system embodiments under the present disclosure;

FIG. 3 shows a DNN (deep neural network) embodiment under the present disclosure;

FIGS. 4a-4b illustrate DNN embodiments under the present disclosure;

FIG. 5 illustrates training phase and online phase embodiments under the present disclosure;

FIG. 6 illustrates a city layout for a telecommunication system under the present disclosure;

FIG. 7 shows results of simulation testing for power consumption and spectral efficiency;

FIG. 8 shows results of simulation testing energy efficiency and spectral efficiency;

FIG. 9 shows results of simulation testing for several hyperparameters;

FIG. 10 shows results of simulation testing energy efficiency and spectral efficiency;

FIG. 11 shows results of simulation testing for several hyperparameters;

FIG. 12 shows results of simulation testing for spectral efficiency;

FIG. 13 shows results of simulation testing for spectral efficiency;

FIG. 14 shows results of simulation testing for power consumption, activated antennas and energy efficiency;

FIG. 15 shows a flow-chart of a method embodiment under the present disclosure;

FIG. 16 shows a flow-chart of a method embodiment under the present disclosure;

FIG. 17 shows a schematic of a communication system embodiment under the present disclosure;

FIG. 18 shows a schematic of a user equipment embodiment under the present disclosure;

FIG. 19 shows a schematic of a network node embodiment under the present disclosure;

FIG. 20 shows a schematic of a host embodiment under the present disclosure;

FIG. 21 shows a schematic of a virtualization environment embodiment under the present disclosure; and

FIG. 22 shows a schematic representation of an embodiment of communication amongst nodes, hosts, and user equipment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

Certain aspects of the disclosure and the embodiments described herein may provide solutions to the challenges described above and other challenges in the art.

In example, consider a time division duplexing (TDD) downlink massive MIMO system with one base station (BS) serving a set of users. One aim of the present disclosure is to maximize the energy efficiency and obtain a trade-off between energy-efficiency and spectral-efficiency through the design of a new deep unsupervised learning algorithm that can find different beamforming structures for both fully digital precoder (FDP) and hybrid beamforming (HBF) structures. A loss function used in the training of an unsupervised learning algorithm can be designed based on an accurate transmitter energy model to improve the energy efficiency. For the FDP case, described embodiments include methods that learn to perform antenna selection, whereas for HBF, it reduces the output power and the number of utilized RF chains.

Certain proposed algorithms can perform antenna selection and hardware configuration by considering the power consumption and insertion loss of all the components involved in each beamforming (BF) structure. To satisfy the connections constraints of different BF structures which have discrete nature, described unsupervised learning algorithms make use of the Gumbel-Sigmoid method inspired by Gumbel-Softmax. The Gumbel-Sigmoid algorithm is designed in such a way that it considers the constraints of all components involved in the BF connections.

For the first time in the context of the DL-based massive MIMO beamforming, the described embodiments can train the deep neural network (DNN) using imperfect channel state information (CSI) not only for the input of the DNN but also to compute the unsupervised loss function.

Embodiments described herein include novel algorithms, driven by unsupervised DNN, to design the optimal energy-efficient hardware configuration and antenna selection for HBF as well as for FDP by developing an accurate energy model for each beamforming structure of the massive MIMO system. The energy model includes the power consumption and insertion loss of all components such as combiners, mixers, power amplifiers, etc.

Embodiments also provide for the design of intelligent loss functions which can provide various trade-offs between energy consumption and spectral efficiency. Embodiments can consider the spectral efficiency, the energy efficiency, and the number of active users in the system.

Embodiments also include the use of imperfect channel state information during the training of the deep unsupervised learning approach. Consequently, the entire process of proposed DL-based solutions can be based on imperfect CSI.

Certain embodiments may provide one or more of the following technical advantages described below. The proposed deep unsupervised learning algorithms are flexible and can be adapted to a variety of hardware configurations, such as hybrid and fully digital architectures. Depending on the beamforming configuration, the proposed algorithms can be trained efficiently while requiring minor changes. Typically, the output layer of the DNN is changed from one beamforming to another. The loss function of each beamforming architecture is designed in such a way to include three terms weighted by some hyperparameters:

$$Loss = - SE + γ EC + ζ AS \qquad Equation 1$$

where SE represents the achieved spectral efficiency, EC represents the energy consumption, and AS represents the adaptive antenna selection based on desired spectral efficiency. The hyperparameters γ and ζ are used to control the weight of each term to obtain the SE-EE trade-off.

Since the proposed algorithms are based on an accurate energy model, the DNN model can design beamforming solutions by considering the hardware configurations and their energy consumption. Furthermore, the proposed loss function reflects the objective of maximizing energy efficiency while it can support a wide range of trade-offs between spectral efficiency and energy consumption.

Certain proposed unsupervised DNNs can be trained using only noisy CSI. As a result, the entire process, that is both the training and evaluation phases, can be performed with CSI obtained during regular operation of the BS.

Some of the embodiments contemplated herein will now be described more fully with reference to the accompanying drawings. Embodiments are provided by way of example to convey the scope of the subject matter to those skilled in the art.

### System Model

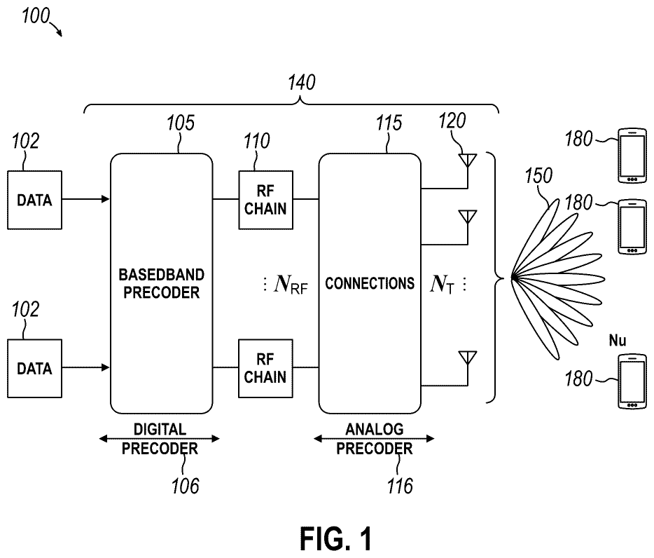

One system embodiment can be illustrated with reference to FIG. 1. System 100 is a downlink massive MIMO system with one BS 140 transmitting to N_{U} single-antenna users 180. The BS 140 is equipped with N_{T} antennas 120 and N_{RF} RF chains 110. The digital precoder (DP) 106 is performed in the baseband 105 on received data 102, and then the output signal goes through the RF chains 110, where each RF chain 110 is composed of a digital-to-analog converter (DAC), a low pass filter (LPF), a local oscillator (LO), and a mixer. The connection between the RF chains 110 and the antennas 120 defines the analog precoder (AP) 116 and can be realized using phase-shifters, switches and combiners. FIG. 1 shows an embodiment of a massive MIMO system model structure with one transmitter BS 140 employing HBF to serve a set of users 180.

The signal received by each user u is given by:

$${y}_{u} = {h}_{u}^{H} A {\sum }_{u = 1}^{{N}_{U}} {w}_{u} {x}_{u} + η , \qquad Equation 2$$

where hᵤ ∈ [symbol] is the channel vector of user u, and x=[x₁, . . . , x_{N}_{_{U}}] is the transmitted symbols of all users with

$$E [ x {x}^{H} ] = \frac{1}{{N}_{U}} {I}_{{N}_{U}}$$

and η is the additive white Gaussian noise with 0 mean and variance σ².

The HBF comprises the DP ψ=[w₁, w₂, . . . , w_{N}_{_{U}}]∈ [symbol] and the AP A=P_{q}×Ω, where P_{q} ∈ [symbol] is the matrix of coefficients of the q bits phase-shifter connecting the antenna 120 and the RF chains 110. The coefficient of the q bits phase-shifter connecting the nth antenna 120 and the mth RF chain 110 can be given by:

$${[ {P}_{q} ]}_{n , m} ∈ \{ {e}^{\frac{j 2 π k}{{2}^{q}}} : k ∈ \{ 1 , 2 , … , {2}^{q} \} \} . \qquad Equation 3$$

The matrix Ω defines the status of the connection between the antenna and the RF chains. It is a binary matrix where the (n,m)th element is 1 if and only if the nth antenna 120 is connected to the mth RF chain 110.

The achievable spectral efficiency (SE) of the massive MIMO system is given by:

$${R}_{HBF} ( A , W ) = {\sum }_{u = 1}^{{N}_{U}} {log}_{2} ( 1 + SIN R ( A , {w}_{u} ) ) , [ in bits / s / Hz ] \qquad Equation 4$$

where SINR(A,wᵤ) is the signal to interference-plus-noise ratio received by user u and is given by:

$$SIN R ( A , {w}_{u} ) = \frac{{\vert {h}_{u}^{H} {Aw}_{u} \vert}^{2}}{{\sum }_{{j = 1}_{j \neq u}}^{{N}_{U}} {\vert {h}_{u}^{H} {Aw}_{u} \vert}^{2} + {σ}^{2}} . \qquad Equation 5$$

One aim is to maximize the energy efficiency (EE) of the massive MIMO system 100. The EE is defined as the ratio between the SE and the power consumption P_{HBF} that will be modelled and formulated further below. The mathematical problem is formulated as follows:

$${max}_{A , W} {R}_{H B F} ( A , W ) / {P}_{HBF} \qquad Equation 6$$

$${\sum }_{u = 1}^{{N}_{U}} {w}_{u}^{H} {A}^{H} A {w}_{u} \leq {P}_{TX} \qquad Equation 7$$

where P_{TX} is the power budget of the BS.

Based on this formulation, the benchmark solutions (the optimal FDP, the approximate solutions for HBF architectures) can be obtained to compare the proposed deep unsupervised learning solution. Time division duplexing is assumed, where the estimated channel in the uplink can be used in the downlink. To be more realistic, an assumption is made that the wireless channel is noisy, that is:

$$\hat{H} = H + βϵ , \qquad Equation 8$$

where H is the actual wireless channel matrix and c is the added white Gaussian noise. The parameter β∈[0,1] is a hyperparameter used in the model to study the impact of the noise on the performance of the proposed solution.

### Energy Model

To optimize the EE, the power consumption of the proposed massive MIMO system should be defined. Doing so can be based on a regularity assumption where components of the same type have the same input/output interface, i.e. their inputs and outputs are connected to the same type and number of components. This assumption is generally true because it eases the conception of generic circuits. Furthermore, there is no reason to differentiate the design for different antennas, as it is costly to fabricate a circuit for a very specific application.

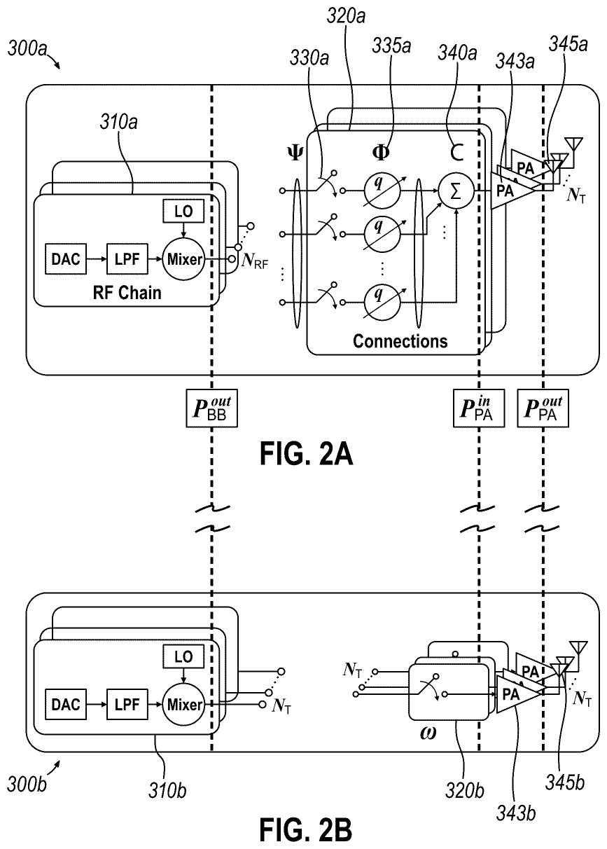

To better represent each HBF structure, a general template form is used, as shown in FIGS. 2a and 2b. FIG. 2a illustrates an embodiment of an HBF structure 300a. FIG. 2b illustrates an embodiment of an FDP structure 300b. Both the HBF structure 300a and the FDP structure 300b comprise RF chain(s) 310a/b, leading to connection(s) 320a/b, leading to power amplifier(s) 343a/b, leading to antenna(s) 345a/b. Different places to measure/detect/monitor power are labeled across both structures as

$${P}_{B B}^{o u t} ,$$

total baseband power output;

$${P}_{P A}^{i n} ,$$

input power to the power amplifier; and

$${P}_{P A}^{o u t} ,$$

output power of the power amplifier.

As seen in FIG. 2a, a given antenna 345a is connected to a combiner 340a having c ∈ {1, . . . , N_{RF}}inputs. Each input of a combiner 340a is connected to the output of a phase shifter 335a. Then, each phase shifter 335a is connected to an RF chain 310a through a switch 330a. The number of switches 330a is ψ ∈ {1, . . . , N_{RF}}. Defining the tuple (ψ,c) fully characterizes the analog precoder structure. The HBF structure 300a can be applied to three possible HBF structures discussed previously:
(N_{RF},N_{RF}) for the FC-HBF structure. In the FC-HBF structure, all the switches are connected (i.e., ψ=N_{RF}), while the outputs of all the phase-shifters are combined before each antenna (i.e., c=N_{RF}).
(N_{RF},1) for the DSA-HBF structure. In DSA-HBF, only one switch can be connected at each time slot, therefore c=1, while there are possible connections for all the switches, thus ψ=N_{RF}. It should be noted that such configuration for switches works like a multiplexer. Thus, in a practical system, the switches are replaced by a ψ×1 multiplexer.
(1,1) for the FSA-HBF structure. In FSA-HBF, each RF chain is only connected to one antenna (i.e., c=1), while the connection is fixed (i.e., ψ=1).

The hardware complexity of different beamforming techniques is compared in Table 1.

TABLE 1
Hardware Complexity Comparison

| | Hardware components | | | | |
|---|---|---|---|---|---|
| | | | Phase- | | |
| BF | RF chains | Antennas | shifters | Combiners | Switches |
| FDP | N_{T} | N_{T} | — | — | — |
| FC-HBF | N_{RF} | N_{T} | N_{RF}N_{T} | N_{T} | — |
| FSA-HBF | N_{RF} | N_{T} | N_{T} | — | — |
| DSA-HBF | N_{RF} | N_{T} | N_{T} | — | N_{T} |

In the following section, the energy consumption of each component is described, and the most recent state-of-the-art hardware solutions are listed. Moreover, because an operating frequency of 28 GHz is assumed, components that are operating in the frequency range of 20-40 GHz are included.

A component is identified by the notation [symbol] c [symbol] that corresponds to an element of the set D, L, M, LO, Ψ, Φ, C, A. The correspondence between a component and its notation is defined in Table 2. We denote I [symbol] as the insertion loss of the passive component and [symbol] (x) as the average power dissipated by active component [symbol] c [symbol] that depends on a tuple of parameter x, defined in Table 2. Note that the power dissipated by wires is neglected and when c=1 there is no need for a combiner (i.e., IL_{C}(1)=0 dB). Likewise, for the switches, if ψ=c, it means all connections are established and when ψ=1, the switches act like wire (i.e., IL_{ψ}(c)=IL_{ψ}(1)=0 dB).

Components to discuss include the RF front-end, passive components, digital-to-analog converter, and low pass filter in the transceiver (TX).

RF Front-End: The RF front-end is known as the circuitry between the antenna and the DAC. As shown in FIG. 2b, for the FDP, this comprises low pass filters (LPFs), mixers, local oscillators (LOs), switches, and power amplifiers (PAs). On the other hand, in FIG. 2a, the HBF uses a network of phase-shifters, splitters, and combiners in addition to the components described for the FDP. The mixers, combiners, and PSs are assumed to be passive devices that introduce IL each.

TABLE 2
Energy Model Notations and Parameters

| Component | Notation [symbol] c [symbol] | Parameter x |
|---|---|---|
| Digital to analog converter | D | #bits b_{D} |
| Low pass filter | L | — |
| Mixer | M | — |
| Local oscillator | LO | — |
| Switches (multiplexers) | Ψ | #inputs ψ |
| Phase-shifters | Φ | #bits q |
| Combiners | C | — |
| Power amplifier | PA | — |

Passive Components: The mixers, combiners, and PSs are assumed to be passive devices that introduce IL each. The insertion loss of the phase shifter and the combiner plays a key role in designing energy-efficient HBF, especially for the FC-HBF, where all the RF chains are connected to all the antennas through phase shifters and a combiner. For the DSA-HBF, the switches dynamically change the connections between the RF chains and the antennas to improve the flexibility of the structure.

For simplicity, we consider a linear scale for all the IL. Now, by assuming that the total baseband output power is

$${P}_{B B}^{o u t} ( mW )$$

then the input power of the PA of the nth antenna for all structures of the HBF can be written as follows:

$${P}_{P A , HBF}^{in , n} = \frac{1}{{N}_{T} {IL}_{C}} {\sum }_{∀ c} \frac{{P}_{B B}^{o u t}}{{IL}_{Ψ} ( s ) {IL}_{Φ} ( q ) {IL}_{M}} ( mW ) , \qquad Equation 9$$

where IL_{Φ}(q) denotes the insertion loss of PS with q bit resolution. In the FC-HBF, where all the RF chains are connected to the antennas, we have (ψ,c)=(N_{RF},N_{RF}) and IL_{ψ}(c)=0 dB, then the previous equation can be rewritten as:

$${P}_{PA , FC}^{in , n} = \frac{{N}_{R F}}{{N}_{T}} ( \frac{{P}_{BB}^{o u t}}{{IL}_{C} ( c ) {IL}_{Φ} ( q ) {IL}_{M}} ) ( mW ) . \qquad Equation 10$$

Similarly, for the DSA-HBF that has a structure (ψ,c)=(N_{RF},1) and a connection matrix Ω_{SA}, and the FSA-HBF that has a structure (ψ,c)=(1,1), and a connection matrix Ω_{DSA}, then the input power of the DSA-HBF can be written, respectively, as:

$${P}_{P A , D S A}^{in , n} = \frac{1}{{N}_{S}} ( \frac{{P}_{BB}^{o u t}}{{IL}_{Ψ} ( s ) {IL}_{Φ} ( q ) {IL}_{M}} ) ( mW ) , \qquad Equation 11$$

$$and$$

$${P}_{PA , FSA}^{i n , n} = \frac{1}{{N}_{S}} ( \frac{{P}_{B B}^{out}}{{IL}_{ϕ} ( q ) {IL}_{M}} ) ( mW ) \qquad Equation 12$$

where N_{S}=N_{T}/N_{RF} denotes the size of the connected subarray. Similarly for the FDP, as shown in FIG. 2b, the input power of the PA can be obtained as:

$${P}_{PA , FDP}^{in , n} = \frac{1}{{N}_{T}} ( \frac{{P}_{BB}^{o u t}}{{IL}_{M}} ) ( mW ) . \qquad Equation 13$$

Based on the above-given beamforming structures, assuming that

$${P}_{P A , B F}^{i n} ∈ \{ {P}_{PA , FC}^{i n} , {P}_{P A , DSA}^{i n} , {P}_{PA , FSA}^{i n} , {P}_{PA , FDP}^{i n} \} ,$$

the DC power drawn by the nth PA can be written as:

$${P}_{PA , BF}^{DC , n} = \frac{{P}_{TX}^{n} - {P}_{PA , BF}^{in , n}}{α} \qquad Equation 14$$

where α is the power-added efficiency (PAE) of the LPA, and

$${P}_{T X}^{n}$$

is the transmitted power by nth antenna, where

$${P}_{T X} = {\sum }_{∀ n} {P}_{T X}^{n} .$$

It also should be noted that because total power constraint is considered, the output power of all antennas is not necessarily equal, whereas the total transmitted power is limited to P_{TX}.

Digital-to-Analog Converter: DACs are among the components having the largest power consumption in wireless applications. The power consumed by a DAC (P_{D}) is a linear function of the sampling frequency (fₛ) and the figure of merit (FoM_{D}) of the converter, and exponentially grows with the number of bits of resolution (b_{D}) as: P_{D}=FOM_{D}×fₛ×2^{bD}. The sampling frequencies for ultra-wide band applications are in the range of 0.5-1 GHz. In terms of required signal to quantization noise ratio (SQNR), FDP required 2 bits less than HBF.

Low Pass Filter in TX: The output of the DACs will require analog LPF to reject spectral images and maintain out-of-band emission limits. For an m'th order active LPF with cutoff frequency fₑ, the FoM_{L} is the power consumed per pole per Hertz. The power drawn by LPF is given by P_{L}=FoM_{L}×f_{c}×m′.

Now, putting it all together, the total power consumed by a given beamforming structure can be written as follows:

$${P}_{B F} = {\sum }_{n = 1}^{{N}_{T}} {P}_{PA , BF}^{DC , n} + {N}_{R F} ( {P}_{L} + {P}_{L O} + {P}_{D} ( {b}_{D} ) ) + {P}_{Φ} {\sum }_{n = 1}^{{N}_{T}} {\sum }_{m = 1}^{{N}_{R F}} {[ Ω ]}_{n , m} \qquad Equation 15$$

where P_{LO} is the consumed power by the mixer from the LO. It should be noted that the previous equation is the general energy consumption, which denotes the HBF with notation P_{HBF} and for FDP, where N_{RF}=N_{T}, it is P_{FDP}. Based on the power consumption of the passive components such as phase shifters and combiners, the power consumed by different HBF structures are almost similar since the insertion loss of the passive components is lower before the PA. However, in terms of hardware complexity and cost, shown in Table 1, the subarray HBF is more efficient than FC-HBF.

The previous equation can be written more generally based on the connection matrix Ω defined previously, as:

$${P}_{B F} = {\sum }_{∀ n} {P}_{PA , BF}^{DC , n} + {‖ {\sum }_{∀ n} {[ Ω ]}_{n , m} ‖}_{0} \times ( {P}_{L} + {P}_{L O} + {P}_{D} ( {b}_{D} ) ) \qquad Equation 16$$

where ∥·∥₀ denotes the cardinality of a vector and Ω ∈ {Ω_{FD}, Ω_{FC}, Ω_{SA}}. It can be seen that both SE and EE depend on matrix Ω which define the connection between RF chains and the antennas, where more connections lead to a higher SE by increasing the flexibility of beamforming, while each connection corresponds to employing an RF chain in FDP, and in case of HBF a PS and a combiner, and it causes more energy consumption.

### Proposed Energy Efficient Beamforming Driven By Deep Unsupervised Learning

The following describes certain embodiments of unsupervised learning solutions to design the antenna selection and efficient HBF as well as FDP. The proposed algorithm is divided into two phases: (i) the training phase and (ii) the online phase. To begin, the DNN architecture is described.

### Deep Neural Network Architecture:

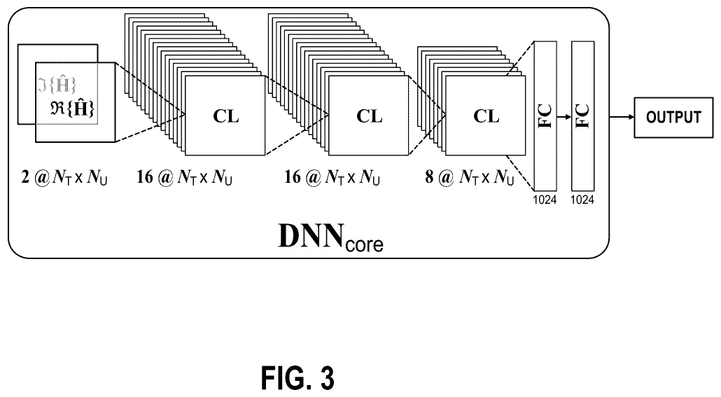

FIG. 3 illustrates an embodiment of a proposed DNN_{core} which is similar for both proposed HBF and FDP. Since the desired DNN output is different for each BF structure, the similar DNN portion of both structures can be described first, called “DNN_{core}”, as shown in FIG. 3. DNN_{core} comprises two convolution layers (CL) 16@N_{T}×N_{U} where 16 denotes the number of channels (or filters) and N_{T}×N_{U} is the dimension of each channel followed by 1 CL 8@N_{T}×N_{U}. The kernel size is 3×3 for all CLs. The CLs are followed by two fully connected layers (FL), each with 512 neurons. The “Leaky ReLU” (Leaky Rectified Linear Unit) activation function is employed after all layers. Leaky ReLU is a type of activation function based on a ReLU. Instead of a flat slope, Leaky ReLU has a small slope for negative values.

Batch normalization is used after each layer to avoid over-fitting. The input of the DNN is the noisy channel matrix H. To improve the representation learning, we first normalize the channel

$${‖ \hat{H} ‖}_{2}^{2} = 1$$

and then separate the real and imaginary parts of Ĥ, respectively denoted [symbol] {Ĥ} and [symbol] {Ĥ}, into two channels in the first CL.

### Output Layers for HBF

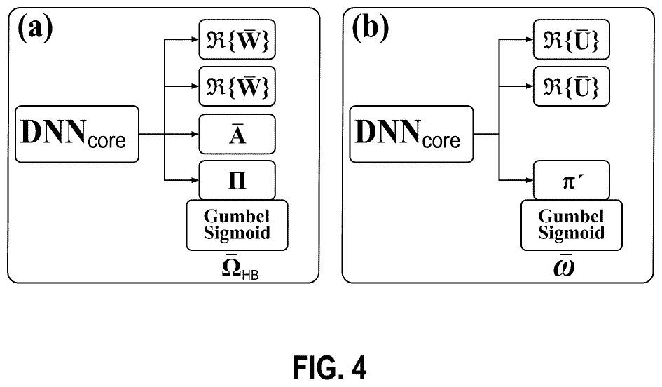

FIGS. 4a and 4b illustrate embodiments of a proposed DNN architecture for (a) Hybrid Beamforming, (b) Fully Digital Precoder.

As shown in FIG. 4a, the output of the last FL is divided into four parallel fully connected layers. Their depth is based on the desired output dimension. The first and second parallel layers, both of size N_{RF}×N_{U}, generate the real and imaginary part of the DP. The output of the third parallel layer generates the AP, thus its dimension is N_{RF}×N_{T}. The output of AP can also be adapted to different phase shifter resolutions.

The fourth layer of size N_{RF}×N_{T} designs the matrix Ω_{HB}. As described above, Ω_{HBE}∈{Ω_{FC}, Ω_{FSA}, Ω_{DSA}}must be a binary matrix. Typically, this binary constraint requires using the Sigmoid function during training and then, during the online phase, applying a rounding technique to transform the real values into binary values. However, the applicant has found that this approach does not lead to good results for unsupervised learning, because the SE measured during training can be very different from the actual SE measured during testing. It is because in the unsupervised learning approach, there are no labels, and thus the output of the DNN would not be saturated to the binary values. To solve this issue, it is proposed to use a differentiable approximation, called Gumbel-Sigmoid during training inspired by the Gumbel-Softmax estimator. The Gumbel-Softmax approximation is a technique that allows sampling from a categorical distribution during the forward pass of a neural network, by combining a re-parameterization trick and a smooth relaxation. Thus, the connection between the RF chains and the antennas can be represented using a categorical binary distribution. Hence, defining π_{n,m} as the probability that antenna n is connected to RF chainₘ, then we can form an N_{T}×N_{RF} matrix that corresponds to the probability states between antenna n and RF chainₘ. The Gumbel-Softmax function, G(H), applied for each element of the matrix H can then be defined as follows:

$${Ω}_{H B} = G ( Π ) = \frac{exp ( ( log ( Π ) + g ) / τ )}{exp ( ( log ( Π ) + g ) / τ ) + exp ( {g}^{′} / τ )} \qquad Equation 17$$

Because 2-class categorical distribution is assumed, the equation yields:

$${G ( Π )}_{1} = \frac{exp ( {x}_{1} )}{exp ( {x}_{1} ) + exp ( {x}_{2} )} = \frac{1}{1 + exp ( {x}_{2} - {x}_{1} )} = Sigmoid ( {x}_{1} - {x}_{2} ) \qquad Equation 18$$

$${G ( Π )}_{2} = \frac{exp ( {x}_{2} )}{exp ( {x}_{1} ) + exp ( {x}_{2} )} = 1 - \frac{1}{exp ( {x}_{2} - {x}_{1} ) + 1} = 1 - Sigmoid ( {x}_{1} - {x}_{2} ) \qquad Equation 19$$

where Ω_{HB} is the output of the DNN, and g and g′ are independent samples with zero mean and unit variance, drawn from the Gumbel distribution. Note that the exp(·) and log(·) functions are applied element-wise when taking a matrix as input. The parameter τ is called the Gumbel temperature. When τ→0, G(Π) tends to the categorical distribution, but when τ→∞, it converges to the uniform distribution. Therefore, there is a trade-off between small temperatures, where sample vectors are close to one-hot but the variance of the gradient is large, and large temperatures, where samples are more uniform but the variance of the gradient is small. Therefore, T is considered as a hyper-parameter to be optimized in our implementation.

### Output Layers for FDP

One proposed architecture for FDP is shown in FIG. 4b. The output layer can be divided into three parallel layers. The first two layers are dedicated to the real and imaginary part of the FDP with dimension N_{T}×N_{U}. The third layer, similar to the one for HBF, designs the antenna selection vector (ω), where if we consider that

$${π}_{n}^{′}$$

is the probability of connected antenna index n, ω=G(π′), where

$${π}^{′} = [ {π}_{1}^{′} , … , {π}_{{N}_{T}}^{′} ] ,$$

and finally Ω_{FD}=diag(ω).

### Training Phase: Unsupervised Learning

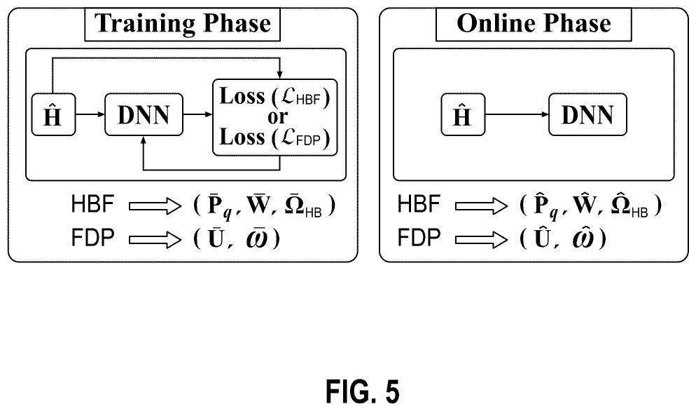

FIG. 5 shows a training phase of a proposed DNN. In one proposed algorithm embodiment, as shown in FIG. 5, it is assumed that in the training phase, the BS, which implements the algorithm, is not transmitting any data and is only measuring the environment and storing the data samples. In the present case, thanks to unsupervised learning, the data samples can comprise a noisy channel matrix without the need for targets (or labels). The noise term includes a coefficient β and a calibration error ϵ as shown in Equation 8. The coefficient β is used to control the noise power and thus helps to study the impact of the noise on the proposed DNN unsupervised learning approach. To make the system model more realistic, the noisy channel model is used even in the training phase to compute the loss function. This makes the proposed model more realistic when compared to the state-of-the-art models that mainly assume perfect channels during training.

### Efficient Hybrid Beamforming (E-HBF-Net)

Initially, one proposed algorithm can start with the HBF structure, called E-HBF-Net, where all the RF chains are connected to all the antennas through PSs. However, to design an efficient HBF structure, the proposed algorithm employs a programmable switch for each connection (N_{T}×N_{RF}) to find the best matrix (Ω_{HB}) that maximizes the EE. As shown in the training phase of FIG. 5, the DNN is designing jointly (i) the DP (W̅= [symbol] {W̅}+i [symbol] {W̅}), (ii) the PS (P̅_{q}) with a regression task, and (iii) the connections between the RF chains and the antennas (Ω_{HB}) by employing the proposed Gumbel Sigmoid function. Note that the proposed DNN aims to not only design the HBF to maximize the SE but also aims to design the connection matrix to improve the EE. Furthermore, the proposed DNN is adaptive in terms of the number of active users, i.e., when the number of active users is small, the proposed DNN intelligently turns off part of the antennas since they will be no longer needed. Consequently, it will reduce energy consumption. That all being said, the unsupervised loss function to train the DNN uses three terms, and it is written as set forth in Equation 1, and here in reference to hybrid beamforming.

$${Loss}^{H B F} = - S E + γ E C + ζ A S \qquad Equation 20$$

where SE represents the achieved spectral efficiency, EC represents the energy consumption, and AS represents the adaptive antenna selection based on desired spectral efficiency. The hyperparameters γ and ζ are used to control the weight of each term to obtain the SE-EE trade-off.

### Maximizing the Spectral Efficiency (SE)

The first term of the loss function corresponds to maximizing the SE by optimizing the AP and DP. Thus, the first term SE is given by the negative of the SE as follows:

$$S E = {R}_{H B F} ( \overline{A} , \overline{W} ) \qquad Equation 21$$

where Ā=p̅_{q} ⊗Ω̅_{HB}. Here, p̅_{q} represents the output of the DNN for the phase shifters and Ω̅_{HB} represents the connection matrix as the output of the DNN after applying the “Gumbel Sigmoid” function that was employed in the noisy channel to compute the SE. Equation 21 can be compared to Equation 6, above. Equation 6 deals with the maximization of the EE, defined as the SE (see Equation 21), divided by the power consumption. The term SE in the loss function is used to maximize the SE where total power constraint is assumed at the BS. Therefore, to satisfy the power constraint, the power can be normalized as

$${‖ \overline{A} \overline{W} ‖}_{2}^{2} = {‖ \overline{U} ‖}_{2}^{3} = {P}_{TX} .$$

However, by considering very low power for

$${P}_{PA , BF}^{in} ,$$

this power normalization makes a constant power consumption for each PA regardless of the connection matrix. The transmitted power can be re-normalized to be a function of the Ω̅ _{HB}.

$${‖ \overline{A} \overline{W} ‖}_{2}^{2} = ( {\sum }_{{∀}_{m , n}} {[ {\overline{Ω}}_{HB} ]}_{n , m} ) {P}_{TX} / ( {N}_{RF} {N}_{T} ) \qquad Equation 22$$

### Minimizing the Energy Consumption (EC)

The second term also corresponds to the connection matrix Ω̅_{HB} designed by the DNN. This term is introduced to add a penalty to the total loss function to reduce energy consumption. It is given as follows:

$$EC = γ {P}_{HBF} \qquad Equation 23$$

where P_{HBF} is the total consumed energy, which depends on i_{HB} that determines the number of utilized PSs, combiners, and PAs. Thus, Ω̅_{HB} affects both the SE as well as the energy consumption. The parameter γ in previous equation is a regularization coefficient used to trade-off between the SE and the EE. It is a hyper-parameter that can be optimized to increase the flexibility of our BF design. It can be seen that when γ→∞, then the DNN ignores the energy consumption and focuses on maximizing the SE with maximum flexibility. On the other hand, when γ→0, then the DNN scarifies the SE to minimize the energy consumption. The effect of different γ values has been shown in the simulation results.

To compute P_{HBF}, we need to compute the consumed power and thus we first need to know the DC power consumed by the PAs. Thus, we would need the input and output power of the PAs. The output power of the PA in n^{th} antenna can be written as:

$${\overline{P}}_{TX}^{n} = {‖ {[ \overline{A} \overline{W} ]}_{n} ‖}_{2}^{2} \qquad Equation 24$$

where Ā, W̅, and Ā=p̅_{q}⊗Ω̅ _{HB} are the AP and DP designed by DNN. However, obtaining the input power of the PAs is challenging because the connection matrix has been designed by the DNN and this matrix is not in the well-known form of FC-HBF and SA-HBF. Therefore, the input power cannot be computed. It should depend on the connection matrix Ω̅_{HB}, where it determines the power splitter after each RF chain and the power combiner before each antenna. Therefore, the input power of the PAs is written as:

$${\overline{P}}_{PA , BF}^{in} = ( \frac{{P}_{BB}^{out}}{{IL}_{C} ( c ) {IL}_{Φ} ( q ) {IL}_{M}} ) ( {\overline{Ω}}_{HB} \times {( {\sum }_{{∀}_{n}} {[ {\overline{Ω}}_{HB} ]}_{n ,} )}^{- 1} ) \qquad Equation 25$$

where [Ω̅ _{HB} ]ₙ denotes the n^{th} row of Ω̅_{HB}, and

$${\overline{P}}_{PA , BF}^{in} = [ {\overline{P}}_{PA , BF}^{in , 1} , … , {\overline{P}}_{PA , BF}^{in , n} , … , {\overline{P}}_{PA , BF}^{in , {N}_{T}} ] .$$

We should determine the number of utilized RF chains to compute the power consumption of total RF chains. However, finding the number of RF chains requires using the cardinality function which is not a differentiable operation, and it makes the back-propagation algorithm fail. Therefore, an expectation over all antennas is defined as follows:

$${N}_{RF}^{sel} = ( \sum {[ {\overline{Ω}}_{HB} ]}_{n ,} ) / {N}_{T} \qquad Equation 26$$

where as mentioned before, Ω̅_{HB}=G(Π), is the output of the Gumbel-Sigmoid function.

### Adaptive Antenna Selection (AS)

The third term AS, is given as follows:

$$AS = ζ {\vert \frac{{R}_{HBF} ( \overline{A} , \overline{W} )}{{N}_{U}} - {R}_{desire} \vert}^{2} \qquad Equation 27$$

where R_{desire} is a predefined desirable average SE value for all users. The first two terms in the loss function provide a trade-off between the SE and the energy consumption by designing the precoders regardless of the number of active users. In a scenario where each user in the mMIMO system requires a predefined SE threshold R_{desire}, the DNN should not focus on maximizing the SE anymore and instead should focus on minimizing the power consumption. Thus, the third term is defined as the difference between the average SE and R_{desire}, where the average SE depends on the number of active users. Thanks to this term, the SE is forced to get close to R_{desire} and not go further while some of the unnecessary antennas (transmitted power) can be turned off to reduce the energy consumption (according to the second term EC). As a result, this term guarantees to consume the minimum power to satisfy the target average rate R_{desire}.

The value of R_{desire} is fixed and predefined by the operator, where higher values lead to higher energy consumption while lower values reduce the number of utilized antennas. For instance, consider a scenario with an optimal achievable SE of 24 b/s/Hz for four users with an average rate per user of 6 b/s/Hz, and another scenario, where the optimal achievable SE is 18 b/s/Hz for two users with an average rate per user of 9 b/s/Hz. By considering R_{desire}=7 b/s/Hz, the first scenario affects the DNN solution less than that of the second scenario because AS=1 in the first scenario and AS=4 in the second scenario. Thus, in the second scenario with two users, the DNN must reduce the number of transmitter antennas to reduce the average rate per user from 9 b/s/Hz to get close to R_{desire}=7 b/s/Hz.

### Fully Digital Precoder (E-FDP-Net)

The DNN for FDP provides the precoder Ū= [symbol] {Ū}+i [symbol] {Ū} and the vector ω̅ for antenna selection. For FDP, the unsupervised loss function to train the DNN is calculated similarly to the case of HBF based on Equation 20 (Loss=−SE+γ′EC+ζAS) by finding the SE, the EC, and the AS terms for FDP. Mathematically, it is defined as follows:

$${Loss}^{FDP} = - {R}_{FDP} ( {\overline{Ω}}_{FD} \times \overline{U} ) + {γ}^{′} {P}_{FDP} + ζ {\vert \frac{{R}_{FDP} ( {\overline{Ω}}_{FD} \times \overline{U} )}{{N}_{U}} - {R}_{desire} \vert}^{2} \qquad Equation 28$$

where the SE for FDP is given by R_{FDP}(Ω̅_{FD}×Ū), the EC for FDP is given by P_{FDP} with a new hyperparameter γ′ and the AS for FDP depends on the SE.
The proposed deep unsupervised learning algorithm comprises a deep neural network having as input the wireless channel Ĥ and trained using the loss function [symbol] _{HBF} or [symbol] _{FDP}, depending on the BF architecture, as illustrated in FIG. 2.

[symbol]

### Online Phase: Transmitting Data

After the training phase, when the DNN is ready to be used for inference, the online phase can be started as shown in FIG. 5. In the online phase, the DNN input is only given by the noisy channel matrices Ĥ. In the online phase, like the training phase, the AP ( [symbol] ) and the DP (Ŵ) in HBF, and the FDP (Û) can be employed without any further processing. However, since the connection matrices are binary, i.e., D in HBF and W in FDP, they require binary quantization. To do so, the element-wise round function (└·┐) can be used on each element of these matrices as follows: \hat{Ω}=└\hat{Ω}┐ for HBF and \hat{ω}=└\hat{ω}┐, and \hat{Ω}_{FD}=diag(\hat{ω}) for FDP. The output power of the E-HBF-Net can be obtained by

$${\hat{P}}_{TX}^{n} = {‖ {[ \hat{A} \hat{W} ]}_{n} ‖}_{2}^{2} ,$$

while for E-FDP-Net it is

$${\hat{P}}_{TX}^{n} = {‖ {[ {\hat{Ω}}_{FD} \times \hat{U} ]}_{n} ‖}_{2}^{2} .$$

### Simulation Results

Applicant ran several simulation using the approaches described herein. Channel simulation results are described below.

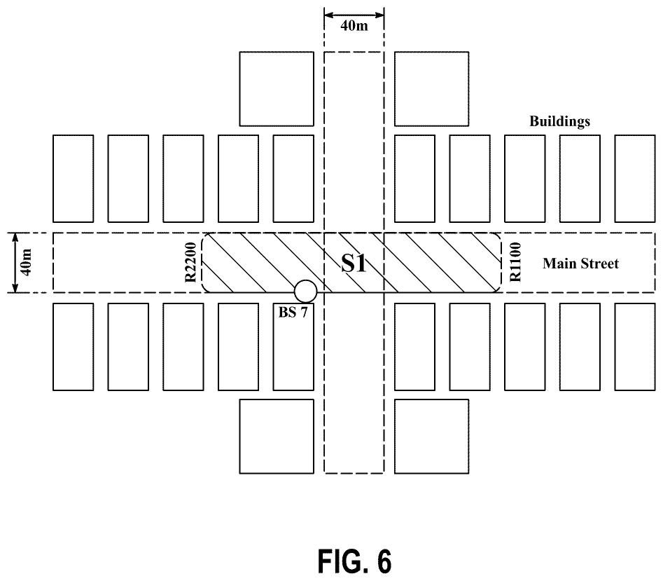

Certain embodiments of a deep unsupervised learning solution require as input the wireless channel and gives as output the BF matrices. One proposed solution of the present disclosure can be evaluated with a realistic ray-tracing channel model known as “deepMIMO”. This dataset contains different massive MIMO scenarios, and simulations were implemented using the scenario “01-28 GHz”. The wireless channel is generated by applying ray-tracing methods to a three-dimensional model of an urban environment. The scenario “01-28 GHz” makes use of several users' locations being randomly generated in two orthogonal streets that intersect in the middle of the area and are surrounded by buildings, such as seen in FIG. 6. FIG. 6 displays the 01-28 GHz scenario of the deepMIMO dataset.

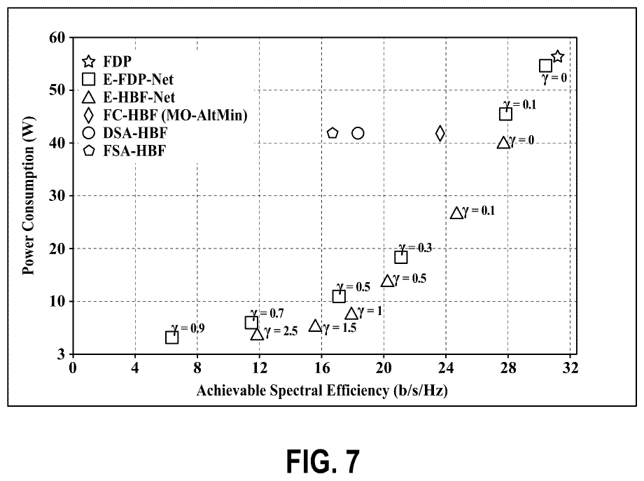

FIG. 7 shows results obtained of power consumption (W) versus achievable spectral efficiency (b/s/Hz). The achieved trade-off between SE and EE is shown when varying the hyperparameters γ and γ′. Comparison is shown between certain proposed solutions (E-FDP-Net and E-HBF-Net) to optimal and benchmark conventional solutions, including FDP, FC-HBF (MO-AltMin), DSA-HBF, and FSA-HBF.

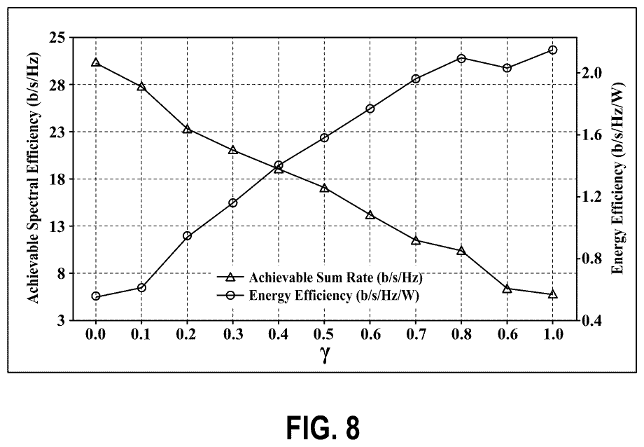

FIG. 8 displays the achieved trade-off between SE and EE when varying the hyperparameter γ′ for the FDP scenario. As can be seen, as EE rises the SE goes down, and vice versa. A crossover point is seen at about γ′=4.

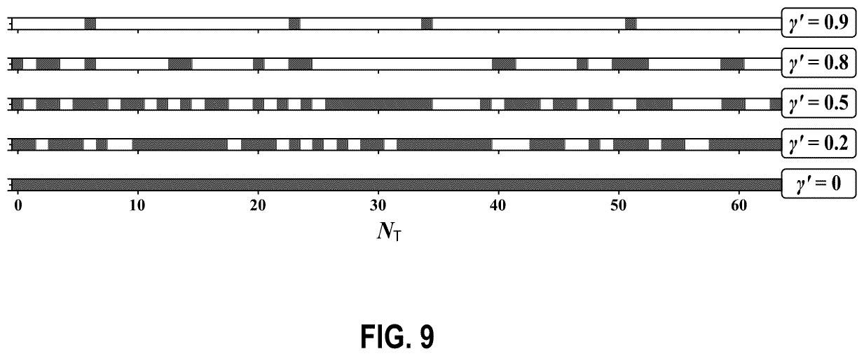

FIG. 9 displays the connection between the RF chains and the antennas for the FDP for different values of the hyperparameter γ′. A gray square represents a connection (a binary value of 1) and a white square represents no connection (a binary value of 0).

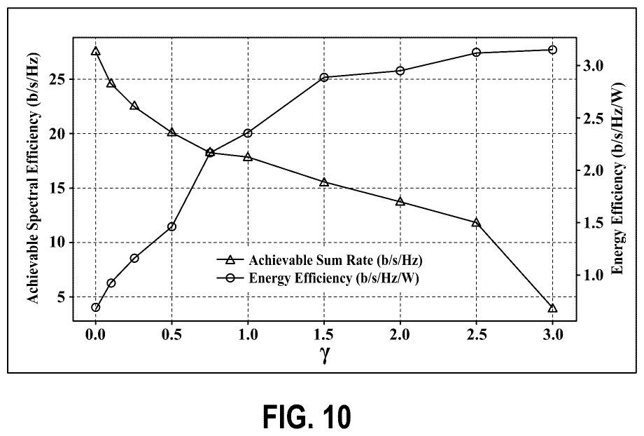

FIG. 10 displays the achieved trade-off between SE and EE when varying the hyperparameter γ for the HBF scenario. As can be seen, as EE rises the SE goes down, and vice versa. A crossover point is seen at about γ=0.7

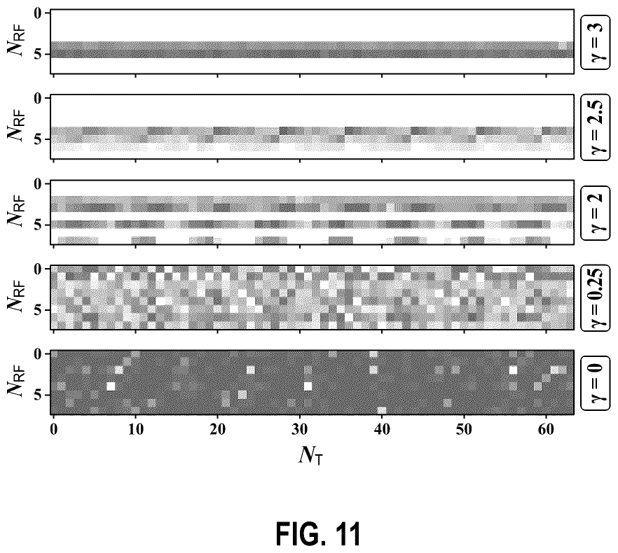

FIG. 11 displays the connection between the RF chains and the antennas for the HBF for different values of the hyperparameter γ. A gray square represents a connection (a binary value of 1) and a white square represents no connection (a binary value of 0).

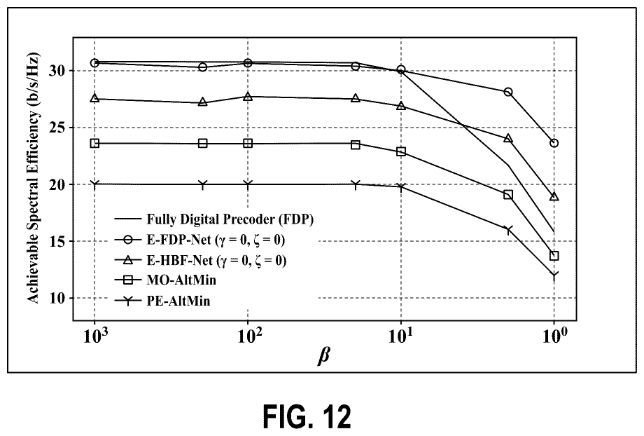

FIG. 12 displays the achieved SE of the proposed solution (E-FDP-Net and E-HBF-Net) compared to other benchmark methods (FDP, MO-AltMin, PE-AltMin) when varying the noise parameter β. Higher values of β means more noise variance.

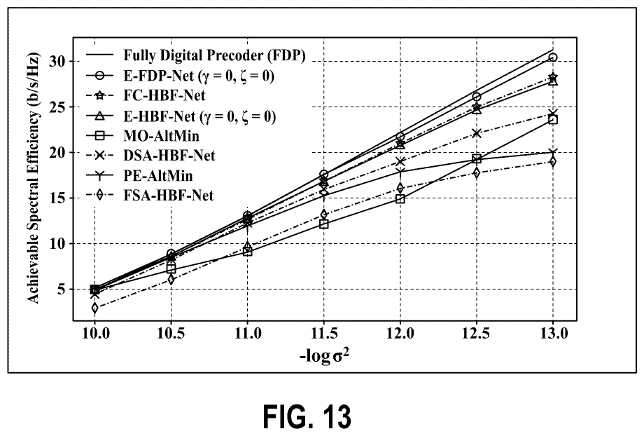

FIG. 13 displays the achieved SE of proposed solutions (E-FDP-Net and E-HBF-Net) for different noise variance compared to benchmark solutions (FDP, MO-AltMin, PE-AltMin, FC-HBF-Net, MO-AltMin, DSA-HBF-Net, and FSA-HBF-Net).

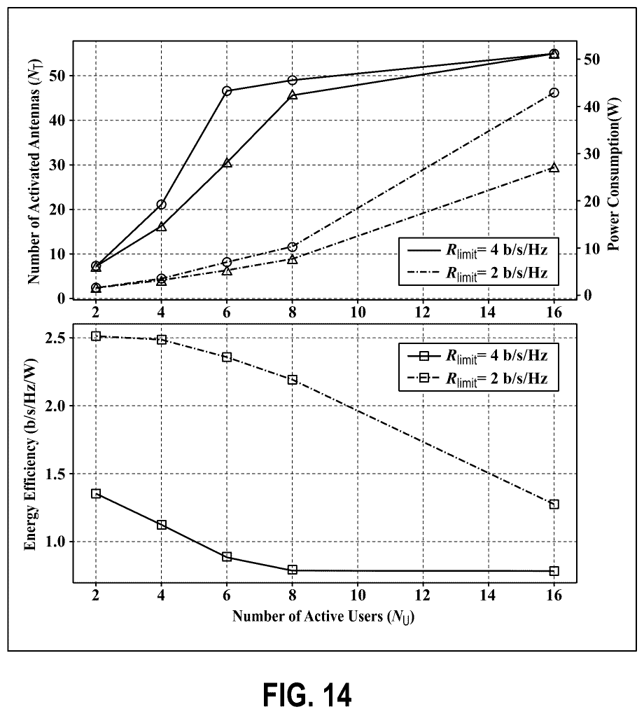

FIG. 14 displays the achieved number of activated antennas and the EE respectively for the FDP when varying the number of active users N_{U} and the SE target R_{target}.

### Additional Embodiments

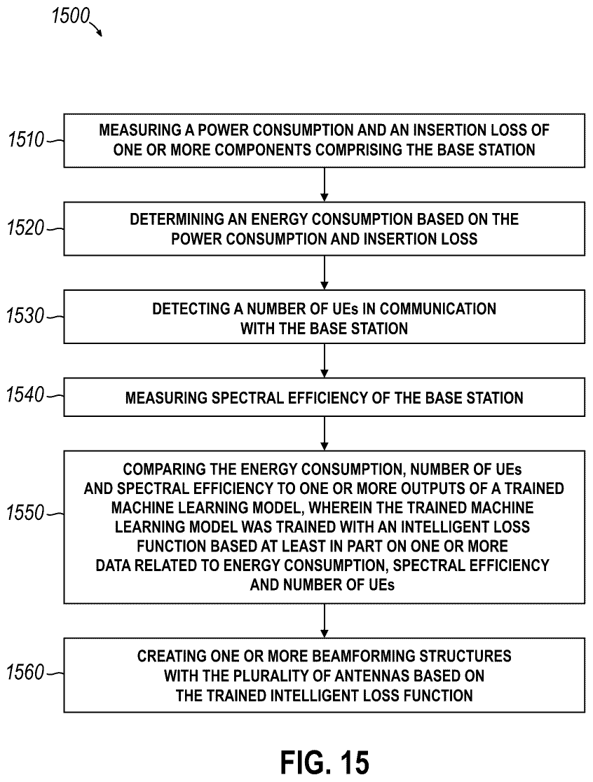

Another possible embodiment under the present disclosure is shown in FIG. 15. Method 1500 comprises a method performed by a base station for performing hybrid beamforming or fully digital precoding e.g., in a MIMO system. Step 1510 is measuring a power consumption and an insertion loss of one or more components comprising the base station. Step 1520 is determining an energy consumption based on the power consumption and insertion loss. Step 1530 is detecting a number of UEs in communication with the base station. Step 1540 is measuring spectral efficiency of the base station. Step 1550 is comparing the energy consumption, number of UEs, and spectral efficiency to one or more outputs of a trained machine learning model, wherein the trained machine learning model was trained with an intelligent loss function based at least in part on one or more data related to energy consumption, spectral efficiency and number of UEs. Step 1560 is creating one or more beamforming structures with the plurality of antennas based on the trained intelligent loss function. The creation of beamforming structures can be accomplished by switching activity, e.g., creating connection between the RF chains and the antennas, yielding different beamforming structures at the BS.

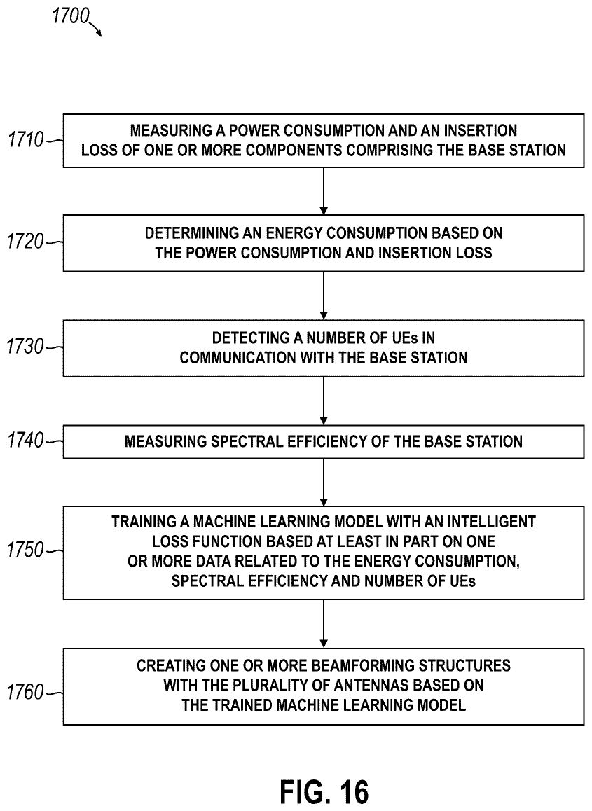

FIG. 16 displays another possible method embodiment under the present embodiment. Method 1700 is a method performed by a base station comprising a plurality of antennas for performing beamforming or fully digital precoding, e.g., in a MIMO system. Step 1710 is measuring a power consumption and an insertion loss of one or more components comprising the base station. Step 1720 is determining an energy consumption based on the power consumption and insertion loss. Step 1730 is detecting a number of UEs in communication with the base station. Step 1740 is measuring spectral efficiency of the base station. Step 1750 is training a machine learning model with an intelligent loss function based at least in part on one or more data related to the energy consumption, spectral efficiency and number of UEs. Step 1760 is creating one or more beamforming structures with the plurality of antennas based on the trained machine learning model.

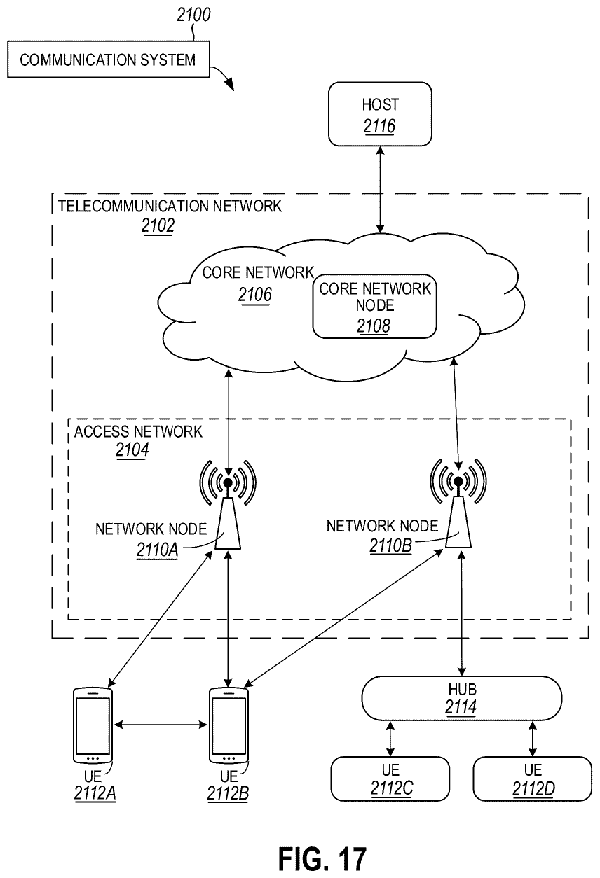

FIG. 17 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

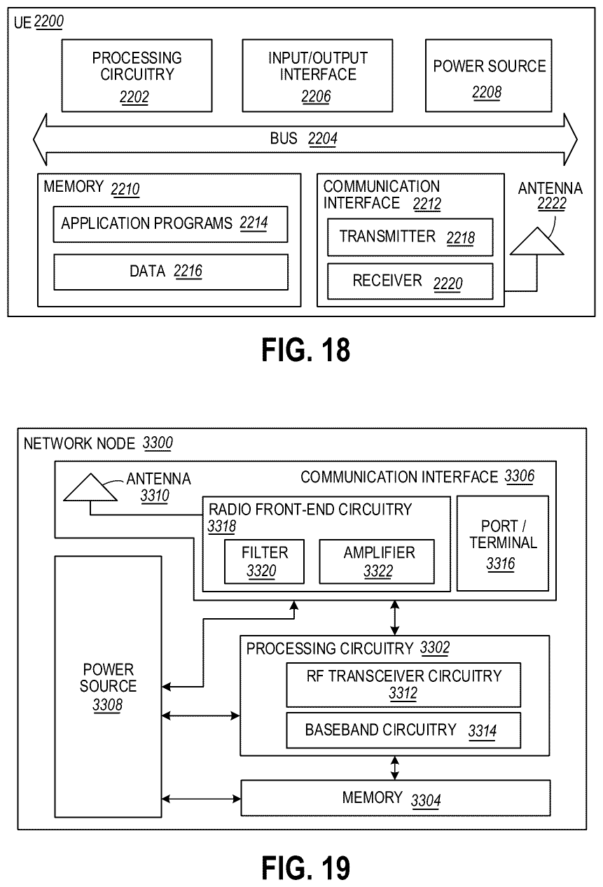

FIG. 18 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known a ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 19 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

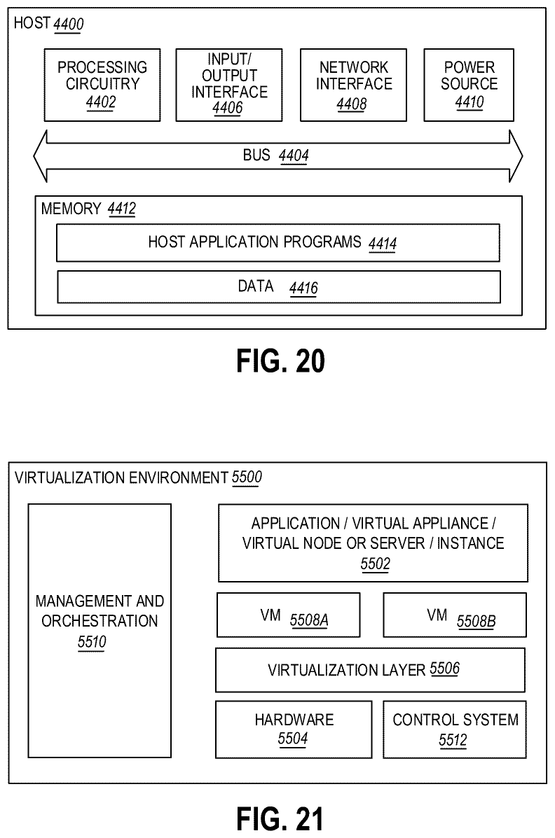

FIG. 20 is a block diagram of a host 4400, which may be an embodiment of the host 2116 of FIG. 17, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 18 and 19, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

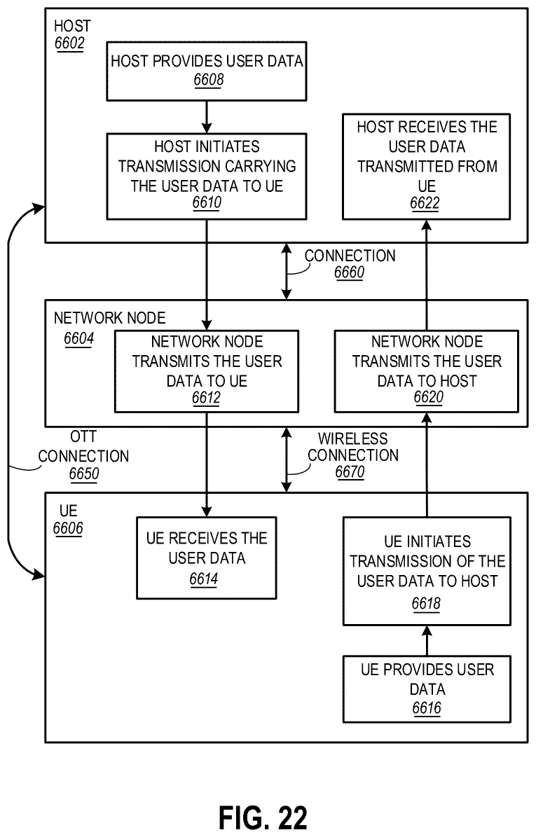

FIG. 22 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 17 and/or UE 2200 of FIG. 18), network node (such as network node 2110a of FIG. 17 and/or network node 3300 of FIG. 19), and host (such as host 2116 of FIG. 17 and/or host 4400 of FIG. 20) discussed in the preceding paragraphs will now be described with reference to FIG. 22.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 17) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

### REFERENCES

1. Joint Antenna Selection and Hybrid Beamforming Design using Unquantized and Quantized Deep Learning Networks; Ahmet M. Elbir, and Kumar Vijay Mishra; IEEE Transactions on Wireless Communications 2020.
2. Unsupervised Deep Learning for Massive MIMO Hybrid Beamforming; Hamed Hojatian, Jérémy Nadal, Jean-François Frigon, and Frangois Leduc-Primeau; IEEE Transactions on Wireless Communications 2021.
3. Deep Unsupervised Learning for Joint Antenna Selection and Hybrid Beamforming; Zhiyan Liu, Yuwen Yang, Feifei Gao, Ting Zhou, and Hongbing Ma; IEEE Transactions on Communications 2022.
4. Flexible Unsupervised Learning for Massive MIMO Subarray Hybrid Beamforming; Hamed Hojatian, Jeremy Nadal, Jean-Francois Frigon, and Francois Leduc-Primeau; IEEE GLOBECOM 2022.
5. PrecoderNet: Hybrid Beamforming for Millimeter Wave System with Deep Reinforcement Learning; Qisheng Wang, Keming Feng, Xiao Li, and Shi Jin; IEEE Wireless Communications Letters, 2020.
6. Sub-Array Hybrid Precoding for Massive MIMO Systems: A CNN-Based Approach; Kai Chen, Jing Yang, Qiang Li, and Xiaho Ge; IEEE Communications Letters, 2021.
7. Dynamic Subarray for Hybrid Precoding in Wideband mmWave MIMO Systems; Sungwoo Park, Ahmed Alkhateeb, and Robert W. Heath; IEEE Transactions on Wireless Communications, 2017.

1. A method performed by a base station comprising a plurality of antennas for performing beamforming in a massive multiple input multiple output, MIMO, system, the method comprising:
measuring a power consumption and an insertion loss of one or more components comprising the base station;
determining an energy consumption based on the power consumption and insertion loss;
detecting a number of user equipments, UEs, in communication with the base station;
measuring spectral efficiency of the base station;
comparing the energy consumption, number of UEs, and spectral efficiency to one or more outputs of a trained machine learning model, wherein the trained machine learning model was trained with an intelligent loss function based at least in part on one or more data related to energy consumption, spectral efficiency and number of UEs; and
creating one or more beamforming structures with the plurality of antennas based on the comparison.

2. The method of claim 1, wherein the one or more data comprises at least one of: channel state information; and imperfect channel state information.

3. The method of claim 1, wherein the training comprises using one or more DNNs, deep neural networks, wherein the one or more DNNs comprise a plurality of convolution layers followed by a plurality of fully connected layers and batch normalization is used after each layer.

4. The method of claim 1, wherein the training comprises unsupervised learning.

5. The method of claim 1, wherein the one or more components comprises one or more of: one or more combiners; one or more mixers; one or more amplifiers; one or more antennas; one or more low-pass filters; one or more digital-to-analog converters; one or more local oscillators; one or more digital precoders; one or more analog precoders; one or more phase shifters; one or more switches; a radio frequency, RF, front end comprising circuitry between an antenna and a digital-to-analog converter; one or more passive components.

6. The method of claim 1, wherein the intelligent loss function comprises the function:
$$Loss = - SE + γ EC + ζ AS$$
where SE represents spectral efficiency, EC represents the energy consumption, AS represents adaptive antenna selection based on desired spectral efficiency, and the hyperparameters γ and ζ are used to control the weight of each term to obtain an SE to energy efficiency trade-off.

7. The method of claim 3, wherein the one or more DNNs comprise a plurality of convolution layers followed by a plurality of fully connected layers.

8. The method of claim 7, wherein batch normalization is used after each layer to avoid over-fitting.

9. The method of claim 3, wherein one of the one or more DNNs is used to perform hybrid beamforming.

10. The method of claim 7, wherein an output of two of the plurality of fully connected layers is divided into four output layers, wherein:
the first and second of the four output layers are configured to generate the real and imaginary part of a digital precoder;
the third layer is configured to generate the analog precoder; and
the fourth layer is configured to design a binary matrix.

11. The method of claim 10, wherein a differentiable approximation is used to generate the fourth layer.

12. The method of claim 11, wherein the differentiable approximation used is the Gumbel-Sigmoid approximation, wherein the Gumbel-Sigmoid function is based at least in part on the Gumbel-Softmax equation, G(Π), applied for each element of a matrix Π, defined as:
$${Ω}_{HB} = G ( Π ) = \frac{exp ( ( log ( Π ) + g ) / τ )}{exp ( ( log ( Π ) + g ) / τ ) + exp ( {g}^{′} / τ )} ,$$
where Ω_{HB} is the output of the DNN, and g and g′ are independent samples with zero mean and unit variance, drawn from the Gumbel distribution.

13. The method of claim 10, wherein the third layer is adapted to different phase shifter resolutions.

14. The method of claim 6, wherein the spectral efficiency of the loss function corresponds to maximizing the spectral efficiency by optimizing one or more analog precoders and one or more digital precoders.

15. The method of claim 6, wherein the loss function is defined for both hybrid beamforming with N_{RF} «N_{T} and for fully digital precoder with N_{RF}=N_{T}, where N_{RF} is a number of RF chains and N_{T} is a number of the plurality of antennas.

16. The method of claim 6, wherein the term γEC of the loss function corresponds to reduce a power consumption of the BS.

17. The method of claim 6, wherein the term ζAS of the loss function corresponds to designing the beamforming based on a number of active UEs and guarantees a minimum energy required to achieve a desired average rate.

18. The method of claim 6, wherein the parameters γ and ζ provide a trade-off between energy consumption and spectral efficiency.

19. A method performed by a base station comprising a plurality of antennas for performing beamforming in a massive multiple input multiple output, MIMO, system, the method comprising:
measuring a power consumption and an insertion loss of one or more components comprising the base station;
determining an energy consumption based on the power consumption and insertion loss;
detecting a number of user equipments, UEs, in communication with the base station;
measuring spectral efficiency of the base station;
training a machine learning model with an intelligent loss function based at least in part on one or more data related to the energy consumption, spectral efficiency and number of UEs; and
creating one or more beamforming structures with the plurality of antennas based on the trained machine learning model,
wherein the intelligent loss function comprises the function:
$$Loss = - SE + γ EC + ζ AS$$
where SE represents spectral efficiency, EC represents the energy consumption, AS represents adaptive antenna selection based on desired spectral efficiency, and the hyperparameters γ and ζ are used to control the weight of each term to obtain an SE to energy efficiency trade-off.

20-32. (canceled)

33. A network node for performing hybrid beamforming or fully digital precoding, the network node comprising:
processing circuitry configured to perform;
measuring a power consumption and an insertion loss of one or more components comprising a base station;
determining an energy consumption based on the power consumption and insertion loss detecting a number of user equipments, UEs, in communication with the base station;
measuring spectral efficiency of the base station;
comparing the energy consumption, number of UEs, and spectral efficiency to one or more outputs of a trained machine learning model, wherein the trained machine learning model was trained with an intelligent loss function based at least in part on one or more data related to energy consumption, spectral efficiency and number of UEs; and
creating one or more beamforming structures with a plurality of antennas of the base station based on the comparison; and
power supply circuitry configured to supply power to the processing circuitry.
